(19) United States
(12) Patent Application Publication
(10) Pub. No.: US 2025/0388474 A1
(43) Pub. Date: Dec. 25, 2025

(54) LASER MANUFACTURING OF GRAPHENE-METAL COMPOSITES

(71) Applicant: George Mason University, Fairfax, VA (US)

(72) Inventors: Pilgyu Kang, Annandale, VA (US); Diego Lobo, Alexandria, VA (US)

(21) Appl. No.: 19/243,597

(22) Filed: Jun. 19, 2025

Related U.S. Application Data
(60) Provisional application No. 63/662,289, filed on Jun. 20, 2024.

(51) Int. Cl. C01B 32/184; C23C 26/00

(52) U.S. Cl. CPC C01B 32/184; C23C 26/00; C01B 2204/22; C01P 2004/03; C01P 2006/40

(57) ABSTRACT

A method of manufacturing a graphene-metal composite includes providing a metal substrate having a graphene precursor layer disposed thereon and irradiating the graphene precursor layer disposed on the metal substrate with a laser to transform the graphene precursor layer into graphene and to embed and bond the graphene in the metal substrate to produce a graphene-metal composite having at least one enhanced characteristic. A system for manufacturing a graphene-metal composite includes a stage configured to support a metal substrate having a graphene precursor layer disposed thereon, a laser configured to irradiate the graphene precursor layer disposed on the metal substrate, and a controller configured to control at least one irradiation setting of the laser to transform the graphene precursor layer into graphene and to embed and bond the graphene in the metal substrate to produce a graphene-metal composite having at least one enhanced characteristic.

### CROSS-REFERENCE TO RELATED APPLICATIONS

This application claims the benefit of U.S. Provisional Patent Application No. 63/662,289, filed on Jun. 20, 2024 and titled “LASER MANUFACTURING OF GRAPHENE-METAL COMPOSITES,” the entire contents of which are hereby incorporated herein by reference.

### FIELD

The present disclosure relates to composite materials and, more specifically, to laser manufacturing of graphene-metal composites.

### BACKGROUND

Advanced composite materials have garnered substantial interest across diverse industries due to their potential to deliver superior mechanical, thermal, and/or electrical properties. Among these, graphene-metal composites represent a particularly promising class of materials.

Current techniques for manufacturing graphene-metal composites range from molten metal processing using arc welding and induction furnaces to advanced methods like continuous synthesis, electrochemical reactors, and chemical vapor deposition (CVD). However, these techniques are complex, costly, and/or difficult to scale. Further, achieving uniform graphene dispersion and consistent performance remains a challenge when manufacturing graphene-metal composites using these techniques.

### SUMMARY

The terms “about,” substantially,” and the like, as utilized herein, are meant to account for manufacturing, material, environmental, use, and/or measurement tolerances and variations, as well as other tolerances and/or variations, and in any event may encompass differences of up to 10%. Further, to the extent consistent, any of the aspects described herein may be used in conjunction with any or all of the other aspects described herein.

Provided in accordance with aspects of the present disclosure is a method of manufacturing a graphene-metal composite including providing a metal substrate having a graphene precursor layer disposed thereon and irradiating the graphene precursor layer disposed on the metal substrate with a laser to transform the graphene precursor layer into graphene and to embed and bond the graphene in the metal substrate to produce a graphene-metal composite having at least one enhanced characteristic compared to a base metal of the metal substrate.

In an aspect of the present disclosure, irradiating the graphene precursor layer disposed on the metal substrate with the laser includes controlling at least one irradiation setting of the laser.

In another aspect of the present disclosure, the at least one irradiation setting includes power, frequency, scan rate, and/or a number of lases.

In still another aspect of the present disclosure, the at least one enhanced characteristic includes electrical conductivity, mechanical strength, corrosion resistance, and/or superconductivity.

In yet another aspect of the present disclosure, the at least one enhanced characteristic includes an increased electrical conductivity of at least 50% or, in aspects, of at least 100%.

In still yet another aspect of the present disclosure, providing the metal substrate having the graphene precursor layer disposed thereon includes applying the graphene precursor layer to the metal substrate. Applying the graphene precursor layer to the metal substrate may include, in aspects, screen printing, spin-coating, or depositing.

In another aspect of the present disclosure, the graphene precursor layer includes a graphite layer or a polymer layer. In alternative or additional aspects, the metal substrate includes copper, aluminum, steel, or titanium.

A system for manufacturing a graphene-metal composite provided in accordance with the present disclosure includes a stage configured to support a metal substrate having a graphene precursor layer disposed thereon, a laser configured to irradiate the graphene precursor layer disposed on the metal substrate, and a controller configured to control at least one irradiation setting of the laser to transform the graphene precursor layer into graphene and to embed and bond the graphene in the metal substrate to produce a graphene-metal composite having at least one enhanced characteristic compared to a base metal of the metal substrate.

In an aspect of the present disclosure, the controller is further configured to control movement of the stage relative to the laser. In such aspects, the controller may be configured to control movement of the stage relative to the laser according to a programmed pattern.

In another aspect of the present disclosure, the controller is configured to control the at least one irradiation setting of the laser based on feedback from the laser.

In still another aspect of the present disclosure, the at least one irradiation setting includes at least one of: power, frequency, scan rate, or a number of lases.

In yet another aspect of the present disclosure, the at least one enhanced characteristic includes at least one of electrical conductivity, mechanical strength, corrosion resistance, or superconductivity.

In still yet another aspect of the present disclosure, the at least one enhanced characteristic includes an increased electrical conductivity of at least 50% or, in aspects, of at least 100%.

In another aspect of the present disclosure, the controller is configured to control the at least one irradiation setting based on at least one of a base metal of the metal substrate or a material of the graphene precursor layer.

### BRIEF DESCRIPTION OF DRAWINGS

The above and other aspects and features of the present disclosure will become more apparent in view of the following detailed description when taken in conjunction with the accompanying drawings wherein like reference numerals identify similar or identical elements.

FIG. 1 is a schematic illustration of laser manufacturing of a graphene-metal composite, e.g., a graphene-copper composite, in accordance with the present disclosure;

FIG. 2 is a schematic illustration of a graphene-metal composite, e.g., a graphene-copper composite, fabricated in accordance with the present disclosure;

FIG. 3 is perspective view of a system for laser manufacturing of graphene-metal composites in accordance with the present disclosure;

FIG. 4 is a block diagram of a controller of the system of FIG. 3;

FIGS. 5A, 5B, and 5C are scanning electron microscope (SEM) images (a), (b), and (c), respectively, at 150× magnification of graphene-metal composites fabricated in accordance with the present disclosure with 1 lase, 2 lases, and 3 lases, respectively;

FIGS. 6A, 6B, and 6C are SEM images at 500× magnification of the respective portions (a1), (b1), and (c1) of images (a), (b), and (c) of FIGS. 5A, 5B, 5C, respectively; and

FIGS. 7A, 7B, and 7C are SEM images at 7000× magnification of the respective portions (a2), (b2), and (c2) of images (a1), (b1), and (c1) of FIGS. 6A, 6B, 6C, respectively.

### DETAILED DESCRIPTION

Laser manufacturing of graphene-metal composites in accordance with the present disclosure yields graphene-metal composites, also referred to as covetics, having significantly enhanced electrical, mechanical, and/or electrochemical characteristics, e.g., electrical conductivity, mechanical strength, durability, corrosion resistance, and/or superconductivity, compared to their base metals. Further, the laser-based graphene-metal composite manufacturing techniques of the present disclosure are cost-effective, scalable, enable uniform graphene distribution and integration, and achieve high homogeneity of the enhanced material characteristic(s) throughout the graphene-metal composites.

The graphene-metal composites fabricated using the laser-based manufacturing techniques of the present disclosure have application across various industries including, without limitation: aerospace, e.g., in aircraft/spacecraft structural components, jet engines, and/or satellite components; electronics, e.g., in microchips, connectors, sensors, and other conductive components of electronic devices; automotive, e.g., in structural components of vehicles, engine components, and battery terminals and casings; energy, e.g., in components of wind turbines, solar panels, and energy storage systems; construction and infrastructure, e.g., as reinforcement materials in concrete, beams, and other structural components; and medical devices, e.g., in surgical tools, implants, sensors, and other biocompatible components.

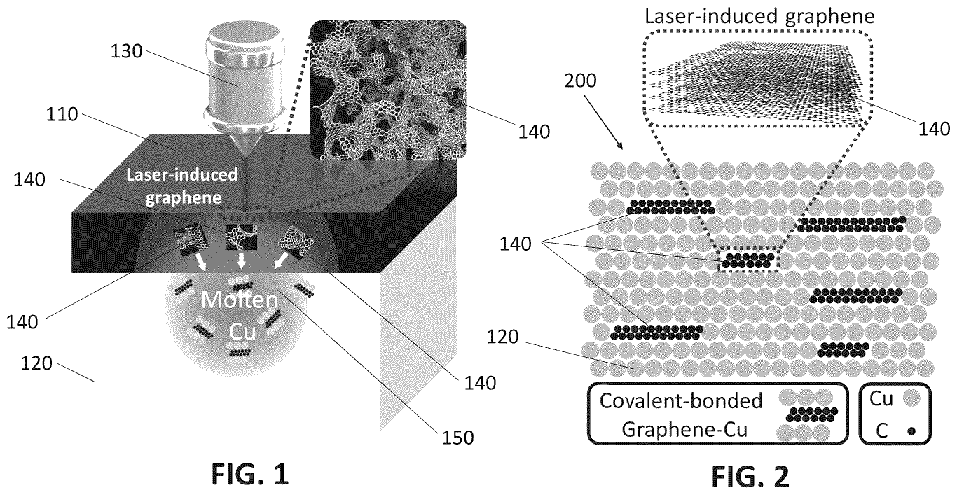

Turning to FIGS. 1 and 2, laser manufacturing of graphene-metal composites in accordance with the present disclosure includes obtaining a metal substrate 120 having a graphene precursor layer 110 disposed thereon and controlling a laser 130 to irradiate the graphene precursor layer 110 disposed on the metal substrate 120 to perform localized transformation of the graphene precursor layer 110 into graphene 140 and localized embedding and bonding of the graphene 140, e.g., in a homogeneous manner, with the metal substrate 120. Relative movement between the laser 130 and the graphene precursor layer 110 disposed on the metal substrate 120, continuously or discretely, enables repeating of this localized transformation of the graphene precursor layer 110 into graphene 140 and localized embedding and bonding of the graphene 140 with the metal substrate 120 along the substantial entirety of the graphene precursor layer 110 disposed on the metal substrate 120 or along any suitable portion thereof and/or in any suitable shape, pattern, or other configuration to produce a graphene-metal composite 200 of a desired configuration.

The graphene precursor layer 110 may be graphite, a polymeric material, e.g., polyimide (PI), or other suitable graphene precursor material, and may be configured as a coating, film, sheet, or in any other suitable configuration. In aspects, obtaining the metal substrate 120 having a graphene precursor layer 110 disposed thereon includes applying the graphene precursor layer 110 to the metal substrate 120 to form the metal substrate 120 having a graphene precursor layer 110 disposed thereon. In such aspects, applying the graphene precursor layer 110 to the metal substrate 120 may include uniformly (e.g., of substantially uniform thickness) applying the graphene precursor layer 110 onto the metal substrate 120. In aspects, applying the graphene precursor layer 110 to the metal substrate 120 includes screen printing, spin-coating, depositing, or other suitable application process. Alternatively, the graphene precursor layer 110 may be pre-formed, e.g., as a film or sheet of material, and applied to the metal substrate 120 using, for example, tape, adhesive, mechanical clamping, fixturing, combinations thereof, and/or in any other suitable manner such that the graphene precursor layer 110 is disposed in fixed relation on the metal substrate 120.

Although copper (Cu) is illustrated as the metal substrate 120 in FIGS. 1 and 2 for fabrication of a graphene-copper composite, the present disclosure is not limited thereto as any other suitable metal may be used as the metal substrate 120. For example, the metal substrate 120 may be copper, aluminum, steel, titanium, or other suitable metal and may be formed as a sheet of metal or in any other suitable manner. The metal substrate 120 may be flexible, rigid, or semi-rigid. In aspects, the metal substrate 120 is cleaned prior to fabrication of graphene-metal composite 330, e.g., to remove oxides and contaminants. In aspects, the metal substrate 120 is cleaned with cleaned with ethanol and deionized water.

Continuing with reference to FIGS. 1 and 2, by controlling the laser 130 in accordance with the present disclosure, the kinetics of both graphene formation and metal reduction are controlled to thereby control the concentration and distribution of the graphene 140 within the resultant graphene-metal composite 200. More specifically, the laser 130 is controlled such that the emitted laser beam locally: transforms the graphene precursor layer 110 into graphene 140 (also referred to as Laser-Induced Graphene (LIG) due to its formation via laser irradiation of a graphene precursor) without vaporizing or otherwise damaging the graphene 140; heats the underlying metal substrate 120 above its melting temperature to melt the metal substrate 120, e.g., into molten metal 150, to form a homogeneous mixture of the graphene 140 (e.g., the LIG) and the molten metal 150; and enables cooling (e.g., by turning the laser 130 off or moving the laser 130 to a different location) whereby interfacial bonding and spatial embedding of the graphene 140 with the metal substrate 120 occurs to form a localized graphene-metal composite portion of graphene-metal composite 200 with a desired concentration and uniform distribution of the graphene 140 within the metal substrate 120 and, thus, a graphene-metal composite portion that yields the desired characteristics.

Movement of the laser 130 relative to the graphene precursor layer 110 disposed on the metal substrate 120 (e.g., via movement of the laser 130 and/or movement of a support stage supporting the graphene precursor layer 110 and the metal substrate 120) enables the above-detailed localized formation, embedding, and bonding of the graphene 140 with the metal substrate 120 to be repeated to produce a graphene-metal composite 200 having graphene-metal composite portions of any suitable shape, pattern, or other configuration. This movement may be incremental or continuous and may follow any suitable pattern depending on the configuration and desired characteristics of the graphene-metal composite 200 to be formed. More specifically, the movement of the laser 130 relative to the graphene precursor layer 110 disposed on the metal substrate 120 may be controlled (together with other irradiation settings of the laser 130) to achieve a desired configuration and characteristics of the graphene-metal composite 200.

The controllable irradiation settings of the laser 130 to facilitate fabrication of the graphene-metal composite 200 may include one or more of: power, frequency, scan rate, wavelength, pulse duration, pulse repetition rate, number of passes (lases), and/or other irradiation settings of the laser 130 such that a desired concentration and distribution of graphene 140 within the metal substrate 120 is achieved in a desired shape, pattern, or other configuration. More specifically, the wavelength of the laser 130 may be set to about 10.6 μm, about 350 μm, or about 355 μm, although other suitable wavelengths are also contemplated, including controllably varying the wavelength. Further, the laser 130 may be pulsed or continuous. The power of the laser 130 may be controllably varied within a range of from about 1 watt to about 10 watts; the frequency of the laser 130 may be controllably varied within a range of from about 30 kHz to about 150 kHz; and/or the scan rate may be controllably varied within a range of about 100 mm/s to about 1000 mm/s. The number of lases may be set at, for example, one (1), two (2), three (3), four (4), etc. However, controlling power, frequency, scan rate, number of lasings, and/or other settings to other suitable values and/or ranges are also contemplated. Other irradiation settings of the laser 130, e.g., pulse duration and pulse repetition rate, may alternatively or additionally be controlled.

In accordance with the present disclosure, control of the irradiation settings of the laser 130 is tailored to the particular materials utilized and/or the particular characteristics sought. More specifically, as different graphene precursor and metal substrate materials have different properties, e.g., vaporization temperatures (for graphene precursors), melting point temperatures (for metals), etc., control of the irradiation settings of the laser 130 may vary depending upon the particular graphene precursor and metal substrate materials utilized. Further, the specific irradiation settings impact the characteristics, e.g., electrical conductivity, mechanical strength, durability, corrosion resistance, and/or superconductivity, of the resultant graphene-metal composite 200 and, thus, control of the irradiation settings of the laser 130 may vary depending upon the particular characteristics sought.

In aspects, after the above-detailed laser treatment, the graphene-metal composite 200 may be cut, polished, and/or otherwise processed to obtain a final product of the graphene-metal composite 200 or multiple graphene-metal composites 200.

Continuing with reference to FIGS. 1 and 2, the graphene-metal composites 200 fabricated in accordance with the present disclosure may be fabricated to exhibit significantly enhanced electrical, mechanical, and/or electrochemical characteristics, e.g., electrical conductivity, mechanical strength, durability, corrosion resistance, and/or superconductivity, compared to the base metals of the metal substrates 120. For example, in aspects, graphene-metal composites 200 fabricated in accordance with the present disclosure exhibit conductivity increases of at least 50%; in other aspects, at least 75%; and in still other aspects, at least 100% compared to the conductivity of the base metals of the metal substrates 120.

The rapid heating and cooling associated with the above-detailed controlled laser irradiation helps break up graphene agglomerates and promote fine-scale mixing, which facilitates electrical and mechanical uniformity throughout the graphene-metal composite 200. Furter, the above-detailed laser processing facilitates direct chemical and physical bonding at the graphene-metal interface, thereby enhancing charge carrier mobility and mechanical load transfer at the nanoscale.

The localized thermal gradients achievable with the above-detailed controlled laser irradiation reduce residence time at elevated temperatures, suppressing undesired carbide and oxide formation that would otherwise degrade conductivity and mechanical properties. In addition, by refining the microstructure of the metal substrate 120, e.g., decreasing grain size, reducing porosity, and/or adjusting phase compositions, the controlled laser processing of the present disclosure can lower electron and phonon scattering, further improving electrical conductivity.

As detailed above, laser irradiation is controlled in accordance with the present disclosure to thereby control localized heating and cooling. This localized heating and cooling control enables control over the distribution, stability, and orientation of the graphene 140 within the metal substrate 120 to establish percolation networks that facilitate efficient electron transport. Using an inert gas environment during laser processing can also minimize oxidative degradation of graphene, preserving its intrinsic conductive properties. Moreover, localized annealing effects induced by the laser 130 can heal structural defects at graphene-metal interfaces and relieve internal stresses within the graphene-metal composite 200.

The controlled laser irradiation in accordance with the present disclosure also enables the formation of well-defined metal-graphene interfaces, where the x-electron system of the graphene 140 can couple efficiently with the conduction electrons of the metal substrate 120, minimizing interfacial resistance and promoting seamless charge transfer. Simultaneously, the controlled melting and solidification (cooling) of the metal substrate 120 enabled by control of the laser 130 permits uniform dispersion of graphene domains within the metal matrix, avoiding agglomeration and ensuring consistent phase distribution across the composite. This dynamic environment promotes non-equilibrium mixing and enables the tuning of interfacial energy states and carrier densities, which are important for electron mobility and reducing scattering losses.

In addition, the above-detailed laser-based manufacturing of graphene-metal composites 200 in accordance with the present disclosure is scalable and compatible with large-area substrates, enabling programmable patterning and high-throughput processing without the need for masks or vacuum systems.

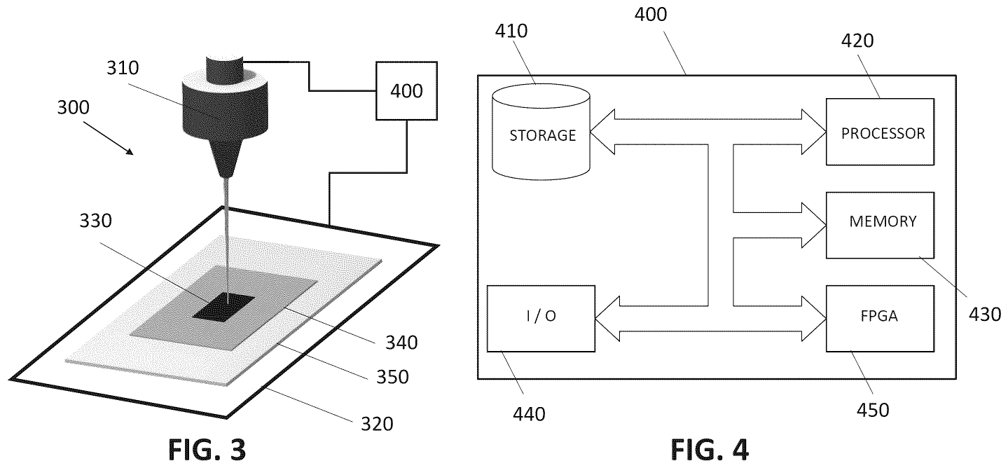

Referring to FIG. 3, a system provided in accordance with the present disclosure for laser manufacturing of graphene-metal composites is shown generally identified by reference numeral 300. The system 300, more specifically, may be configured to implement any or all of the aspects and features detailed above. The system 300 includes a laser 310, a support stage 320, and a controller 400 and is configured to produce a graphene-metal composite 330 by controlling irradiation of the laser 310 during one or more passes, or lases, of the laser 310 over a graphene precursor layer 340 disposed on a metal substrate 350 and supported on the support stage 320. The laser 310 may be CO₂ laser operating in the ultraviolet (UV) or near infrared (IR) spectrum, or any other suitable laser. In aspects, the laser 310 is a UV CO₂ laser having a wavelength of 10.6 μm or a near IR CO₂ laser having a wavelength of 350 μm or 355 μm, although other wavelengths are also contemplated, including laser configurations capable of varying the wavelength. Further, the laser 310 may be a pulsed laser (or have a pulsed operation mode), e.g., a millisecond, microsecond, nanosecond, picosecond, and femtosecond pulsed laser) or may be a continuous laser (or have a continuous operation mode). In aspects, the laser 310 includes controllable power, frequency, scan rate, and number of passes (lases) settings. More specifically, the laser 310 may have a controllable power setting that is variable from at least about 1 watt to about 10 watts; a controllable frequency setting that is variable from at least about 30 kHz to about 150 kHz; and/or a controllable scan rate that is variable from at least about 100 mm/s to about 1000 mm/s. The number of lases may be variably set to, for example, one (1), two (2), three (3), four (4), etc. The pulse duration and/or pulse repetition rate of the laser 310 may additionally or alternatively be controlled.

The above and/or other irradiation settings of the laser 310 are set and/or controlled by the controller 400 to transform the graphene precursor layer 340 into graphene and embed and bond the graphene in the metal substrate 350 to produce, as detailed above, a graphene-metal composite 330 with uniform graphene distribution and integration and high homogeneity of enhanced material characteristics throughout the graphene-metal composite 330 or in a particular shape, pattern, or other configuration. As also detailed above, the particular irradiation settings of the laser 310 set by and controlled from the controller 400 may vary depending at least on the graphene precursor layer and metal substrate materials utilized and/or on the desired characteristics of the resultant graphene-metal composite 330.

The support stage 320 of the system 300 is configured to support the metal substrate 350 having the graphene precursor layer 340 disposed thereon. The support stage 320, in aspects, is movable in x, y, and/or z-axis directions relative to the laser 310. In aspects, the support stage 320 is motor-driven and controlled by the controller 400 during fabrication, e.g., according to a programmed pattern, to produce, in cooperation with controlling the laser 310, a graphene-metal composite 330 having a desired configuration and characteristics.

The metal substrate 350 may be secured to the support stage 320 using, for example, tape, adhesive, mechanical clamping, fixturing, combinations thereof, and/or in any other suitable manner such that the metal substrate 350 is supported on and in fixed relative to the support stage 320.

In aspects, both opposing faces, e.g., the upper and lower surfaces, of the metal substrate 350 are coated with a graphene precursor layer 340 and, in such aspects, laser irradiation (in one or more lases) of both opposing faces is performed. In order to achieve this two-sided laser irradiation, multiple lasers 310 may be provided, e.g., at least one on each opposing face side, or the metal substrate 350, having the graphene precursor layers 340 disposed thereon, may be flipped over during the fabrication process.

With additional reference to FIG. 4, the controller 400 includes a processor 420 connected to a computer-readable storage medium or a memory 430 which may be a volatile type memory, e.g., RAM, or a non-volatile type memory, e.g., flash media, disk media, etc. In aspects, the processor 420 may be, without limitation, a digital signal processor, a microprocessor, an ASIC, a graphics processing unit (GPU), field-programmable gate array (FPGA), or a central processing unit (CPU). In aspects, the memory 430 can be random access memory, read-only memory, magnetic disk memory, solid state memory, optical disc memory, and/or another type of memory. In aspects, the memory 430 can be separate from the controller 400 and can communicate with the processor 420 through communication buses of a circuit board and/or through communication cables such as serial ATA cables or other types of cables. In aspects, the controller 400 further includes an input/output (I/O) 440 to enable communication with the laser 310, other computers, and/or a server. In aspects, a storage device 410 may be used for storing data. In aspects, the controller 400 may include one or more FPGAs 450. The FPGA 450 may be used for executing various algorithms, e.g., fixed algorithms, machine learning algorithms, etc.

The memory 430 of the controller 400 includes computer-readable instructions that are executable by the processor 420 to operate the controller 400, e.g., instructions to be executed by the processor 420 for controlling the laser 310 and/or the support stage 320 to thereby control fabrication of graphene-metal composite 330 in accordance with the present disclosure. More specifically, the controller 400 controls the power, frequency, scan rate, number of passes (lases), and/or other irradiation settings of the laser 310 to transform the graphene precursor layer 340 into graphene and embed and bond the graphene in the metal substrate 350 to produce the graphene-metal composite 330 with desired characteristics, as detailed hereinabove. The controller 400, in aspects, also controls movement of the laser 310 and/or the support stage 320 to achieve a desired configuration of the graphene-metal composite 330.

In aspects, the controller 400 is configured to implement feedback-based control wherein the laser irradiation settings are adjusted during fabrication in real-time (within accepted technical, physical, and practical limits), e.g., based on feedback received from the laser 310, cameras, sensors, etc.

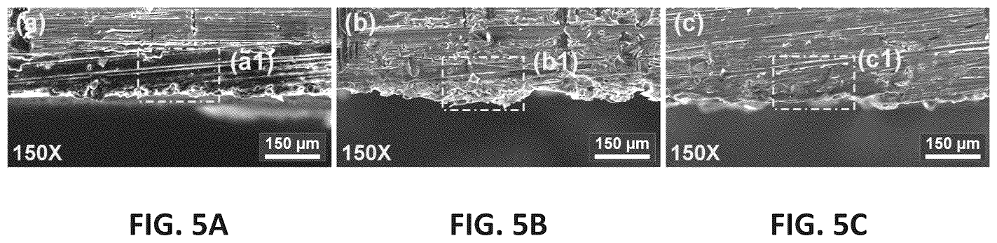

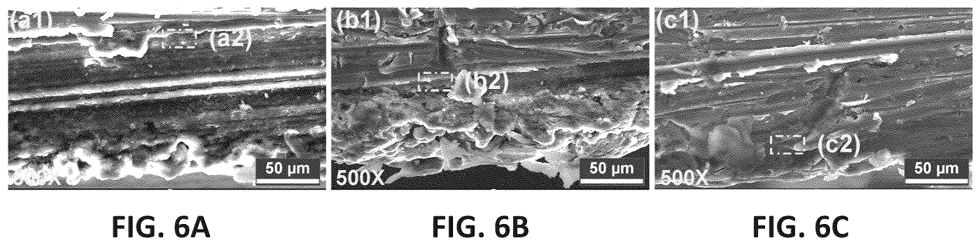

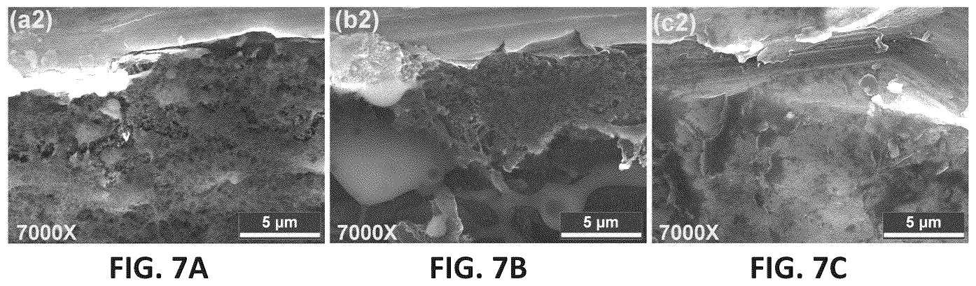

Turning to FIGS. 5A-7C, scanning electron microscope (SEM) images of graphene-metal composites fabricated in accordance with the present disclosure with different numbers of passes, e.g., lases, of laser irradiation are shown. More specifically, FIGS. 5A, 6A, and 7A illustrate portions of a graphene-metal composite fabricated with one (1) lase; FIGS. 5B, 6B, and 7B illustrate portions of a graphene-metal composite fabricated with two (2) lases; and FIGS. 5C, 6C, and 7C illustrate portions of a graphene-metal composite fabricated with three (3) lases.

While these results showed a progressive increase in carbon content with repeated lasing, e.g., 7.21% by weight for the one lase graphene-metal composite; 12.42% by weight for the two lase graphene-metal composite; and 19.85% by weight for the three lase graphene-metal composite, the results also show that the excess carbon in the two and three lase graphene-metal composites becomes structurally disordered, poorly integrated with the metal matrix, and exhibits signs of overprocessing, e.g., surface ablation, delamination, and the formation of fragmented or irregular carbon structures, which impede electrical performance. The one lase graphene-metal composite, on the other hand, exhibits a uniform, moderately porous carbonized layer tightly bonded to the copper surface, indicating good interfacial contact and structural continuity, which are signs of increased electrical performance (as well as other increased performance such as corrosion resistance).

Indeed, the one-lase graphene-metal composites (FIGS. 5A, 6A, and 7A) exhibit the most favorable carbon nanostructure, including the largest crystallite size, the lowest defect density ((D)/I(G)), and the highest degree of graphitization (I(2D)/I(G)). In contrast, the two-lase and three-lase graphene-metal composites showed increasing structural disorder, as evidenced by higher I(D)/I(G) ratios, lower I(2D)/I(G) values, and broader 2D peaks.

The above experimental results highlight the importance of controlling laser settings in accordance with the present disclosure to achieve the desired characteristics of the graphene-metal composite. Of course, while one lase of laser irradiation produced the best results for the experiment results detailed above, which involved the use of copper (Cu) as the base substrate, it is not necessarily the case that one lase of laser irradiation always produces the best results. Rather, in accordance with the present disclosure, laser irradiation settings are controlled based on the materials (e.g., of the graphene precursors and the metal substrate) as well as based on the desired characteristics and configuration of the resultant graphene-metal composite to produce a graphene-metal composite having the desired characteristics and configuration.

While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular configurations. Those skilled in the art will envision other modifications within the scope and spirit of the claims appended hereto.

What is claimed is:

1. A method of manufacturing a graphene-metal composite, comprising:
providing a metal substrate having a graphene precursor layer disposed thereon; and
irradiating the graphene precursor layer disposed on the metal substrate with a laser to transform the graphene precursor layer into graphene and to embed and bond the graphene in the metal substrate to produce a graphene-metal composite having at least one enhanced characteristic compared to a base metal of the metal substrate.

2. The method according to claim 1, wherein irradiating the graphene precursor layer disposed on the metal substrate with the laser includes controlling at least one irradiation setting of the laser.

3. The method according to claim 2, wherein the at least one irradiation setting includes at least one of: power, frequency, scan rate, or a number of lases.

4. The method according to claim 1, wherein the at least one enhanced characteristic includes at least one of electrical conductivity, mechanical strength, corrosion resistance, or superconductivity.

5. The method according to claim 1, wherein the at least one enhanced characteristic includes an increased electrical conductivity of at least 50%.

6. The method according to claim 1, wherein the at least one enhanced characteristic includes an increased electrical conductivity of at least 100%.

7. The method according to claim 1, wherein providing the metal substrate having the graphene precursor layer disposed thereon includes applying the graphene precursor layer to the metal substrate.

8. The method according to claim 7, wherein applying the graphene precursor layer to the metal substrate includes at least one of: screen printing, spin-coating, or depositing.

9. The method according to claim 1, wherein the graphene precursor layer includes a graphite layer.

10. The method according to claim 1, wherein the graphene precursor layer includes a polymer layer.

11. The method according to claim 1, wherein the metal substrate includes at least one of copper, aluminum, steel, or titanium.

12. A system for manufacturing a graphene-metal composite, the system comprising:
a stage configured to support a metal substrate having a graphene precursor layer disposed thereon;
a laser configured to irradiate the graphene precursor layer disposed on the metal substrate; and
a controller configured to control at least one irradiation setting of the laser to transform the graphene precursor layer into graphene and to embed and bond the graphene in the metal substrate to produce a graphene-metal composite having at least one enhanced characteristic compared to a base metal of the metal substrate.

13. The system according to claim 12, wherein the controller is further configured to control movement of the stage relative to the laser.

14. The system according to claim 13, wherein the controller is configured to control movement of the stage relative to the laser according to a programmed pattern.

15. The system according to claim 12, wherein the controller is configured to control the at least one irradiation setting of the laser based on feedback from the laser.

16. The system according to claim 12, wherein the at least one irradiation setting includes at least one of: power, frequency, scan rate, or a number of lases.

17. The system according to claim 12, wherein the at least one enhanced characteristic includes at least one of electrical conductivity, mechanical strength, corrosion resistance, or superconductivity.

18. The system according to claim 12, wherein the at least one enhanced characteristic includes an increased electrical conductivity of at least 50%.

19. The system according to claim 12, wherein the at least one enhanced characteristic includes an increased electrical conductivity of at least 100%.

20. The method according to claim 1, wherein the controller is configured to control the at least one irradiation setting based on at least one of a base metal of the metal substrate or a material of the graphene precursor layer.
